(19) United States
(12) Patent Application Publication
(10) Pub. No.: US 2006/0235673 A1
(43) Pub. Date: Oct. 19, 2006

(54) Radio communication network cell configuration model optimization device

(75) Inventors: Arnaud Gonguet, Paris (FR); Gerard Delegue, Cachan (FR); Stephane Betge-Brezetz, Paris (FR); Lionel Fournigault, Gif Sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/377,371

(22) Filed: Mar. 17, 2006

(30) Foreign Application Priority Data
Mar. 18, 2005 (FR) 0550697

(51) Int. Cl. G06F 17/50

(52) U.S. Cl. 703/14

(57) ABSTRACT

A device is dedicated to optimizing configuration models of cells of a radio communication network. The optimization device comprises processor means adapted to analyze configuration data representing each model used to configure each cell of the network and any associated configuration parameter exception value(s) in order to determine analysis data representing a usage for each model in association with an exception value of at least one configuration parameter and to compare the analysis data to rules describing optimization of models as a function of usage in association with at least one exception value of at least one configuration parameter to determine optimizations of model(s).

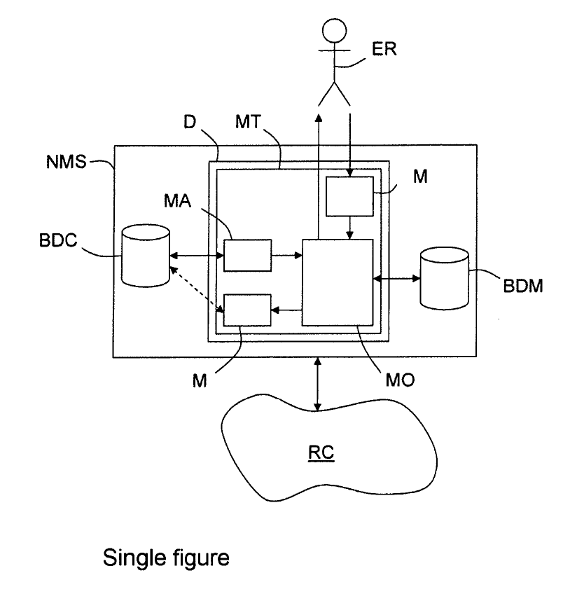

### CROSS-REFERENCE TO RELATED APPLICATIONS

This application is based on French Patent Application No. 0550697 filed 18/03/2005, the disclosure of which is hereby incorporated by reference thereto in its entirety, and the priority of which is hereby claimed under 35 U.S.C. §119.

### BACKGROUND OF THE INVENTION

1. Field of the Invention

The invention relates to radio (or cellular) communication networks and more precisely to optimizing models (also known as “templates”) that are used to configure the cells of such networks.

In the present context the expression “configuration model” means a combination of at least one group of configuration parameters of cells associated with respective selected values.

2. Description of the Prior Art

The radio access networks of certain cellular networks (for example of GSM or UMTS type) are configured by establishing in each of their cells values selected from a group of configuration parameters. This is known in the art. Most cells can be configured with groups of configuration parameters that depend on their type. For example, rural cells are generally configured with one group of configuration parameters whereas urban cells are generally configured with another group of configuration parameters. This is why it is particularly advantageous to predefine standard models (or templates) for each type of cell.

As different types of environment may be encountered in the same type of cell, a plurality of sets of different values may likewise be provided for certain groups of configuration parameters, each set then constituting a particular standard model. It is important to note that a cell can be configured using values of groups of parameters constituting a plurality of standard configuration models dedicated to different aspects, for example quality of service (QoS) and handover (transfer between cells).

However, it may happen that no standard predefined model corresponds to the configuration required for one of the cells. This is generally the result of a local feature interfering with calls, for example a hill in a rural cell or a large building in an urban cell. When this situation is encountered, it generally suffices to change the value of a single configuration parameter of a standard model to adapt the configuration of the cell to its environment. The cell concerned is then configured using the standard model and a so-called “exception value” that replaces the inappropriate value. It is preferable to reuse a standard model associated with an exception value rather than to define an additional standard model because the task of optimizing the network becomes more difficult as the number of standard models increases.

The systematic use of exception values causes at least three problems.

A first problem is that it is not possible to reconfigure a plurality of cells with a standard model associated with the same exception value. In a situation of this kind, the cells must be reconfigured one after the other, associating the exception value with the standard model each time.

A second problem is that, if a parameter value must be replaced by an exception value in a large number of cells (or even in all cells), there is no automatic updating mechanism for reconfiguring each of the cells concerned since there is no new standard model including said exception value as the standard value.

A third problem is that a standard model may be used less when it is associated only with its set of standard values than when it is associated with its set of standard values and a particular exception value. In this situation, the standard model may be considered to be ill-defined and therefore of little utility for network optimization.

Thus an object of the invention is to solve some or all of the problems cited above.

### SUMMARY OF THE INVENTION

To this end, the invention proposes a device for optimizing configuration models of cells of a radio communication network, each model consisting of at least one group of cell configuration parameters associated with respective selected values, which device comprises processor means adapted to analyze configuration data representing each model used to configure each cell of the network and any associated configuration parameter exception value(s) in order to determine analysis data representing a usage for each model in association with an exception value of at least one configuration parameter and to compare the analysis data to rules describing optimization of models as a function of usage in association with at least one exception value of at least one configuration parameter to determine optimizations of model(s).

The optimization device of the invention may have other features and in particular, separately or in combination:
its processor means may be adapted to determine from the configuration data the number of cells configured with only a model and the number of cells configured with that model associated with an exception value in order to determine the usage of each model in association with at least one exception value; in this case the processor means are adapted, once they have determined a number of cells configured with a model and before determining the corresponding usage, to compare that number to a selected threshold in order to proceed to the determination of the usage only if the number of cells configured using that model is greater than the selected threshold; this avoids optimizing a model that is not used very much;
its processor means may be adapted, in the event of reception of an authorization relating to a model optimization that they have determined, to store the optimized model in first storage means in which data representing the models is stored;
alternatively, its processor means may be adapted to store the data defining at least some of the optimized models that they have determined automatically in first storage means in which data representing the models is stored;
it may include the first storage means;
the processor means may be adapted, in the event of storing data representing an optimized model in the first storage means, to update the configuration data so that it is consistent with the data representing the optimized model;
at least some of the rules may be “condition/action” type rules; in this case, at least some of the conditions may apply to a usage threshold value, for example;
its processor means may be adapted to proceed to the determination of a new optimization of a model if the time elapsed since the last optimization of that model is greater than a selected threshold time; in this case, the processor means may be adapted to store data representing each model optimization in corresponding relationship to an optimization date, for example, and to determine the time that has elapsed since the last optimization of a model by comparing the current date to the stored date of the last optimization of the model;
its processor means may be adapted to proceed to the determination of a new optimization of a model if the rate of replacement of the model by an optimized model is greater than a selected threshold rate;
it may include second storage means in which the configuration data of the cells of the network is stored.

The invention also proposes a radio communication network management system (NMS) or a radio communication network services management system of the operation support system type (OSS) equipped with an optimization device of the type described hereinabove.

### BRIEF DESCRIPTION OF THE DRAWING

Other features and advantages of the invention will become apparent on reading the following detailed description and examining the appended drawing, the single FIGURE whereof is a functional block schematic of one embodiment of a management device of the invention installed in a network management system. The appended drawing constitutes part of the description of the invention as well as contributing to the definition of the invention, if necessary.

### DETAILED DESCRIPTION OF THE PREFERRED EMBODIMENT

An object of the invention is to enable automatic optimization of configuration models (or “templates”) of cells of a radio (or cellular) communication network.

It is considered hereinafter, by way of nonlimiting example, that the cellular network is of GMS type. The invention is not limited to that type of cellular network, however. It relates to any type of radio communication network in which the radio access network includes cells that can be configured by means of configuration parameter values and in particular networks of UMTS or GPRS/EDGE type, as well as all equivalents thereof.

The invention relating neither to the operation nor to the configuration of a cellular network, its operation and its configuration will not be described hereinafter. Suffice to say that the cells of a cellular (or radio) network can be configured by means of one or more sets of values of groups of configuration parameters each constituting a predetermined configuration model. A cell may be configured by means of sets of values of groups of parameters constituting a plurality of standard configuration models dedicated to different aspects, for example quality of service (QoS) and handover (transfer between cells).

Configuration can be controlled by a network management system (NMS), in particular if the network is associated with only one type of service, for example voice in the case of a GSM network. In this case, each cell is configured using at least one set of configuration parameter values. Alternatively, configuration may be controlled by a network service management system of the operation support system (OSS) type, for example, in particular if the network is associated with a plurality of service types, for example voice, video and data in the case of a UMTS network. In the latter case, certain cells may have at least one set of configuration parameter values for each type of service that it provides.

To enable automatic optimization of the configuration models of the cells of a radio network RC, the invention proposes an optimization device D of the type shown in the single FIGURE by way of nonlimiting example.

As shown in the single FIGURE, an optimization device D of this kind can be integrated into a network management system NMS. However, the optimization device D could equally be connected to the network management system NMS or integrated into or connected to a network services management system of OSS type.

The optimization device D of the invention essentially comprises a processor module MT that may be divided into a plurality of functional modules as shown here and as explained hereinafter.

The processor module MT is responsible for analyzing configuration data representing, firstly, each model used by the network RC to configure each of the cells of its radio access network and, secondly, configuration parameter exception value(s), if any, associated with the model. The configuration data is stored in a configuration storage module BDC that takes the form of a configuration database, for example, or any other storage means. As shown in the single FIGURE, the configuration storage module BDC may be part of the network management system NMS. However, the configuration storage module BDC could equally be integrated into the optimization device D.

This analysis of the configuration data is intended to determine analysis data representing the usage of each model in association with an exception value of at least one of its configuration parameters. In other words, the analysis aims, for example, to determine for each standard model, in the configuration data that is stored in the configuration storage module BDC, the number of cells configured using only that standard model and the number of cells configured using that standard model associated with an exception value, and then to determine the usage of each standard model in association with at least one exception value.

For example, this analysis (of statistical type) may demonstrate that in 15% of cases a standard model M1 is used in association with the exception value V1 of the configuration parameter P3. The analysis may equally demonstrate, for example, that in 95% of cases a standard model M2 is used in association with at least one exception value of a configuration parameter P2. These examples of analysis results constitute what is referred to hereinafter as “analysis data”.

The determination of the usage of a model in association with an exception value need not be systematic. It may be envisaged that, once it has determined the number of cells configured with a model and before determining the corresponding usage, the processor module MT compares that number to a selected threshold and proceeds to determine the usage only on condition that the number of cells configured using that model is above the threshold. This additional comparison operation can avoid the optimization of models that are not used very much.

As shown in the single FIGURE, the analysis function described above may be implemented by an analyzer module MA of the processor module MT.

Once the analysis has been completed for one or more or all the standard (configuration) models used in the network RC, the processor module MT compares the analysis data to rules each of which defines an optimization of the model as a function of a usage in association with at least one exception value of at least one configuration parameter.

These rules are drawn up by an expert ER. The optimization device D preferably comprises an interface MD through which it receives these rules.

The rules are preferably of “condition/action” type, that is to say: “if a condition is satisfied (or fulfilled) then an optimization action may be effected”. In the present context the expression “optimization action” refers to a proposal to create a new standard configuration model resulting from the replacement in a standard configuration model of one value of a configuration parameter with another value, previously considered to be an exception value.

For example, a rule might take the form: “if a standard configuration model is used in association with an exception value of a configuration parameter in 10% of cases, then a new standard configuration model may be created using that exception value”. This rule indicates that, because of the relatively frequent use of an exception value with a standard model, it is advantageous to create a new additional standard configuration model. Another rule might take the following form, for example: “if a standard configuration model is used in association with at least one exception value of a configuration parameter in 90% of cases, then that standard configuration model may be replaced by a new standard configuration model incorporating that exception value”. This rule indicates that, because of the virtually systematic use of an exception value with a standard configuration model, it is advantageous to replace that standard configuration model with a new standard configuration model incorporating the exception value.

Here each percentage represents a threshold that may be modified by the expert ER as a function of what is required, for example via the interface MD. Of course, other types of rules may be used in which the conditions may apply to inclusion in a range defined by two usage threshold values, for example.

The processor module MT therefore uses rules to determine (by comparing one or more thresholds) if optimization of model(s) may be envisaged.

Each time that the processor module MT detects that optimization may be envisaged, it generates and sends to the expert ER a message describing the optimization proposal. If the expert ER accepts the optimization proposal, the processor module MT is informed of this, for example via the interface MD. It then creates a new standard configuration model by replacing in the standard configuration model that is being optimized the value of the configuration parameter concerned with the associated exception value. This new standard configuration module can then be added to the set of standard configuration models or substituted in the set of standard configuration models for the standard configuration model from which it was derived.

To this end, the processor module MT uses the data that defines the standard configuration models. The model data is stored in a model storage module BDM that takes the form of a model database, for example, or any other storage means. As shown in the single FIGURE, the model storage module BDM may be part of the network management system NMS. However, it could equally be part of the optimization device D.

It is equally possible to envisage that the processor module MT automatically creates a new standard configuration model each time that it has determined an optimization proposal, without authorization by the expert ER being required, and then proceeds to integrate it into the model storage module BDM or substitute the new standard configuration model for the (virtually) unused standard configuration model in the model storage module BDM.

As shown in the single FIGURE, the functions of determining model optimization proposals and creating new standard configuration models described above may be implemented by an optimization module MO of the processor module MT.

Each time that it has stored in the model storage module BDM data representing a new standard model integrating an exception value, the processor module MT preferably proceeds to update the configuration storage module BDC. To this end, the processor module MT may search the configuration storage module BDC for all cells whose identifiers have until then been stored in corresponding relationship to the identifier of the “old” standard model associated with that exception value, for example. It then replaces the identifier of each old standard model (associated with the exception value concerned) with the identifier of the new model that integrates that exception value.

This updating is intended to make the configuration data that is stored in the configuration storage module BDC consistent with that which is stored in the model storage module BDM.

As shown in the single FIGURE, the updating function described hereinabove may be implemented by a reconfiguration module MR of the processor module MT.

As the configurations of certain cells may be modified frequently, the processor module MT may frequently make optimization proposals, which may lead to some instability of the system. To prevent this type of instability, it is advantageous for the processor module MT (for example its optimization module MO) to use a control mechanism.

For example, that control mechanism may consist in authorizing the determination of a new optimization of a standard model only on condition that the time that has elapsed since the last optimization of that standard model is greater than a selected threshold time.

To this end, the processor module MT (for example its optimization module MO) may store a history of the optimizations of each standard model in a memory, for example. To this end, each time that it determines an optimization proposal for a given standard model, it stores in the memory data representing the identifier of that standard model in corresponding relationship to data representing its optimization date. Accordingly, if the processor module MT wishes to proceed to a new optimization of a standard model, it determines in the memory the date of the last optimization of that standard model and then compares that date to the current date in order to calculate the time that has elapsed since the last optimization. The processor module MT then compares that elapsed time to the threshold time and proceeds to the new optimization if the elapsed time is greater than the threshold time.

The control mechanism may instead consist in authorizing the determination of a new optimization of a standard model only on condition that the rate of replacement of that standard model by an optimized standard model is greater than a selected threshold rate, for example.

Faced with a standard model M1 having a usage equal to that of the some standard model associated with an exception value M1′, there is the risk of looped conversion from M1 to M1′ and then from M1′ to M1. Consequently, auxiliary rules may be provided to prevent any such situation arising. An auxiliary rule of this kind may take the following form, for example: “the rate of exchange of a standard model by a new standard model must not be equal to 50%”. In this case, in the presence of equal probabilities, M1 is not replaced by M1′ or vice versa.

The optimization device D of the invention, and in particular its processor module MT, its configuration storage module BDC and its model storage module BDM, when present, may take the form of electronic circuits, software (or electronic data processing) modules, or a combination of circuits and software.

The invention is particularly advantageous in that it ensures that a standard configuration model always corresponds to the most probable network configuration requirement. Furthermore, the number of standard configuration models being minimized, it is easier to select them and to establish in the network the sets of values of groups of configuration parameters that constitute them.

The invention is not limited to the optimization device and network management system embodiments described hereinabove by way of example only, and encompasses all variants that the person skilled in the art might envisage that fall within the scope of the following claims.

1. A device for optimizing configuration models of cells of a radio communication network, each model consisting of at least one group of cell configuration parameters associated with respective selected values, which device comprises processor means adapted to analyze configuration data representing each model used to configure each cell of said network and any associated configuration parameter exception value(s) in order to determine analysis data representing a usage for each model in association with an exception value of at least one configuration parameter and to compare said analysis data to rules describing optimization of models as a function of usage in association with at least one exception value of at least one configuration parameter to determine optimizations of model(s).

2. A device according to claim 1, wherein said processor means are adapted to determine from said configuration data the number of cells configured with only a model and the number of cells configured with that model associated with an exception value in order to determine said usage of each model in association with at least one exception value.

3. A device according to claim 2, wherein said processor means are adapted, once they have determined a number of cells configured with a model and before determining the corresponding usage, to compare that number to a selected threshold in order to proceed to the determination of said usage if said number of cells configured using that model is greater than said selected threshold.

4. A device according to claim 1, wherein said processor means are adapted, in the event of reception of an authorization relating to a particular model optimization, to store said optimized model in first storage means in which data representing said models is stored.

5. A device according to claim 1, wherein said processor means are adapted to store the data defining at least some of the optimized models in first storage means in which data representing said models is stored.

6. A device according to claim 4, including said first storage means.

7. A device according to claim 4, wherein said processor means are adapted, in the event of storing data representing an optimized model in said first storage means, to update said configuration data so that it is consistent with said data representing the optimized model.

8. A device according to claim 1, wherein at least some of said rules are “condition/action” type rules.

9. A device according to claim 8, characterized in that at least some of said conditions apply to a usage threshold value.

10. A device according to claim 1, wherein said processor means are adapted to proceed to the determination of a new optimization of a model if the time elapsed since the last optimization of that model is greater than a selected threshold time.

11. A device according to claim 10, wherein said processor means are adapted to store data representing each model optimization in corresponding relationship to an optimization date and to determine said time that has elapsed since the last optimization of a model by comparing the current date to the stored date of the last optimization of said model.

12. A device according to claim 1, wherein said processor means are adapted to proceed to the determination of a new optimization of a model if the rate of replacement of said model by an optimized model is greater than a selected threshold rate.

13. A device according to claim 1, including second storage means in which said configuration data of the cells of the network is stored.

14. A radio communication network management system comprising an optimization device according to claim 1.

15. A radio communication network services management system comprising an optimization device according to claim 1.
